(19) United States
(12) Patent Application Publication
(10) Pub. No.: US 2005/0132183 A1
(43) Pub. Date: Jun. 16, 2005

(54) Method and system for user created personal private network (PPN) with secure communications and data transfer

(76) Inventor: Glenn Gearhart, Huntington Beach, CA (US)

Correspondence Address: Joseph C. Andras;MYERS DAWES ANDRAS & SHERMAN LLP, Suite 1150, 19900 MacArthur Blvd., Irvine, CA, 92612, US

(21) Appl. No.: 10/737,685

(22) Filed: Dec. 16, 2003

(51) Int. Cl. H04L 9/00

(52) U.S. Cl. 713/150

(57) ABSTRACT

Methods and systems are provided for any individual with access to a network to create, operate and thereafter dismantle a personal private network (PPN) which is secure across all forms of media which facilitate digital data transfer, including but not limited to, both wireless and wireline based networks. In one embodiment, utilizing browser-based management objects and a PPN client server the present invention provides for any individual with access to the Internet or other types of networks to create, control and utilize his own PPN with any one or a plurality of authorized participants. This invention facilities this capability with the creation of secure pipelines between each authorized participant of the PPN, where, if necessary, to establish these secure pipelines, a tunnel under, around or through border servers and/or firewalls is created. Each PPN provides the authorized participants with complete freedom to communicate, to review information and to transfer data between participants with full and complete encryption security. The creation, operation and the dismantlement of a PPN is totally within the capabilities and control of the originating party, the source client, and requires no actions from any network or system administrators. Additionally, all of the PPN secure pipeline creation and infrastructure mapping for the enablement of the PPN, plus access controls and codes for authorizing participation and initiating participation and disconnection can be encased in a PPN secure access key.

### FIELD OF THE INVENTION

The present invention relates generally to both wireline and wireless networks and to a system or method for providing any computer users with the ability to on-demand create secure communications and data transfer pipelines with encryption to prevent unauthorized access to the digital content being transferred through the network. A more particular aspect of the present invention is related to enabling any unskilled party, with access to a digital based network, to establish, maintain, operate and dismantle a secure personalized private network (PPN), which utilizes a set of browser-based management objects, an PPN client server, and secure pipelines to link the participants of this PPN, which can be established upon demand and directed to any specific participant or any multiple numbers of participants.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described and in the drawings hereto: Copyright 2002-2003, ACAP Security, Inc., All Rights Reserved.

### BACKGROUND OF THE INVENTION

This invention focuses on addressing at least two major issues associated with the communications and processing of information. The first is the issue of security in the transfer of information particularly when the routing of the information includes the transfer of the information over wireless communication networks, and the second, is the difficulty and inability of an average computer user to establish and control a specific personalized secure communications and data transfer network between a defined set of participants.

### Network Security Weaknesses

In recent years the issue of the security, confidentiality and integrity of data which is transferred between points has become increasingly important. This concern has greatly increased as a result of the significant increase in the number and usage of both wireline and wireless communication systems and wireless devices which communicate with other wireless networks and wireline networks, often in a local area network (LAN) or a wide area network (WAN) configuration which may include both private and public usage networks and access points.

An indication of the wireless transmission security weaknesses are discussed in the recent prior art in: U.S. Pat. No. 6,580,704, Wellig, Jun. 17, 2003, 370/338, tilted: Direct mode communication method between two mobile terminals in access point controlled wireless LAN systems; and also in: U.S. Pat. No. 6,650,616, Crawford, Nov. 18, 3003, 370/203, tilted: Transmission security for wireless communications.

The issues of the inflexibility of WANs, LANs, VPNs and similar network structures are discussed in the recent prior art in: U.S. Pat. No. 6,640,302, Subramaniam, Oct. 28, 2003, 713/169, titled: Secure Intranet Access; in: U.S. Pat. No. 6,643,701, Aziz, Nov. 4, 2003, 709/227, tilted: Secure Comm with Relay; in: U.S. Pat. No. 6,629,243, Kleinman, Sep. 30, 2003, 713/613, titled: Secure communications system multi-cast groups; in: U.S. Pat. No. 6,631,416, Bendinelli, Oct. 7, 2003, 709/227, tilted: Secure Tunnels P to P.

Information exchanged between points is commonly sent in packet format. Packets of information (also referred to herein simply as “packets” or “data packets”) are a defined set of data bits which carry information such as source address, destination address, synchronization bits, data, error correcting codes, etc. One standard communication protocol for transmitting packets of information between wireless devices and access points is the IEEE 802.11(x) standard, the newer 802.16(x) and at least one more tentatively identified as 802.20(x), although other protocols exist.

Wireless devices capable of communicating in accordance with the IEEE 802.11 and 802.xx protocols and other protocols are readily available from many manufacturers and are capable of operating on a wireless network that is connected to another wireless or wireline network. However, inspire of these protocols and there inherent security features, often individuals wishing to compromise the security, confidentiality and integrity of any network, and particularly wireless networks, may effectively monitor and steal data from the communications occurring between authorized wireless devices and access points within the wireless and wireline networks. The monitoring and theft activities allow an unauthorized party to ascertain a system ID and other control and system administration information within and about the network, as well as gain the ability to place unauthorized traffic on the network, manipulate data, and commit other cyber-criminal acts.

The 802.11 protocol, and its various derivates for wireless applications, includes a degree of security; however, there are difficulties in implementing many of the security features and both wireless and wireline networks continue to demonstrate serious security weaknesses, in spite of the existing prior art.

In view of the aforementioned shortcomings associated with existing wireless and wireline networks, and the existing prior art, there exists a strong need in the art for both a wireless network and a wireline network capability which permits secure communications and data transfer without substantial risk of compromise of the transmitted information. Furthermore, their exists the need for such a data transfer security system to allow flexibility in the mobility of the network user participants and also flexibility in the computer devices and operating software and hardware platforms utilized by the participants.

As discussed in the claims and in the detailed description the present invention effectively addresses each of these security and the associated mobility and flexibility issues.

### Network Creation and Control Weaknesses

As is apparent from the prior art which address digital communications, wireless networks and wireline networks, are often created to establish a local area network (LAN) or a wide area network (WAN) configuration, which may include both private and public usage and access points, allow users to access data files and computer programs, regardless of where the users are geographically located. Until recently, the establishment and operation of a computer network, particularly a LAN or a WAN, was limited to the larger organizations or service providers with sufficient capital and IT technically skilled personnel.

Also apparent from the prior art is the more recent development of the dedicated virtual private network (VPN). This customized communication service has tended to reduce the complexity and costs associated with the engineering of connections between dedicated locations, but requires the network service provider to manage security of the VPN, as the VPN operational components and data links are shared with other customers. A virtual private network is “virtual” because it uses a shared or a base network, such as the Internet as its backbone as opposed to a completely private network with dedicated lines. It is also “private” since the information that is exchanged between the users on the network may be encrypted or encoded to provide privacy. Prior to the present invention, communicating securely between to points, whether it be over virtual private networks, dedicated point-to-point lines, or packet switched networks, they all shared the same drawbacks of being cumbersome and costly.

Although traditional VTNs offer low access costs, they often entail high set-up, maintenance, and management costs. Based on a number of factors, a shared network such as the Internet has evolved as the preferred backbone for connecting and internet-working multiple locations, partners, and employees. Also, the Internet offers the advantages of being ubiquitous, (available almost everywhere—small towns, large cities, around the world), offering an enormous capacity, and increasing cost-effectiveness.

With the ubiquities and security weaknesses of the Internet, VTNs have emerged as a way to build a private communication network over a shared public or private infrastructure or a base network which may include both wireline and wireless networks. VTNs provide secure private connections over the Internet by enabling authentication of users and locations, delivering secure and private “tunnels” between users or locations, and encrypting user communications.

However establishing a VTN over the Internet and over some multiple-based Intranets is often difficult because most robust solutions require esoteric networking and security technologies. Merely deciding what type of VTN and what levels of security or encryption are required can be confusing to many information technology (IT) personnel and certainly to non-IT personnel. Beyond the complex purchase decisions, the installation and ongoing maintenance of such systems can be time-consuming, especially if the number of remote locations changes frequently.

In addition, many organizations have found that rolling out traditional VTN product requires significant logistical planning to make sure that the right hardware and software is available at all the remote locations. Initial configuration of these remote sites is often time consuming enough, without factoring in the effort required to bring a remote site back on line if a location fails. That negative impact is especially true if no skilled IT staffing or resources are available at the remote site.

Time-consuming and costly remote access problems have long been associated with VPNs, therefore many organizations have been reluctant to establish Internet-based and even multiple-based Intranet VPNs because of the increasing number of Internet security threats, such as cyber-crimes and corporate espionage. Furthermore, VTNs and Internet-based connectivity solutions continue to remain prohibitively expensive for small and mid-sized businesses. Even pre-packaged virtual private network solutions often require the expensive support of experienced networking personnel to configure, install, and manage such networks. In addition, the installation of a VPN often requires support at the remote locations, dictating either extensive travel requirements for home office personnel or the hiring and training of remote IT support staff.

Furthermore, VPNs typically limit the secure communications and data transfers to only those parties who are pre-assigned to the VPN. The addition of parties to the VPN, and deletion of parties from the VPN, is time consuming, and is typically limited to being performed by a select set of skilled IT personnel.

Therefore, although based upon the prior art we have LANs and WANs and VPNs we still do not have the capability for an individual computer user to upon demand create a personalized, specific recipient defined private, secure network. A personal private network (PPN) where the individual, unskilled, users can at will add specific recipient parties, delete specific recipient parties and dissolve the network, to thereafter on demand create a new and totally differently configures PPN.

### SUMMARY OF THE INVENTION

To address the above weaknesses in the prior art and other limitations of the prior art, systems and methods are provided that easily and effectively leverage the power of a shared public network, such as the Internet, with one or multiple Intranets in the establishment of secure private connectivity without the complexity, cost, or time associated with setting up traditional LAN, WAN or VPN. Rather than requiring specialized IT staffing and resources, the present invention, PPN, with the defined methods and systems, is capable of allowing an unsophisticated user with access to a standard personal computer (PC), a laptop computer, personal digital assistant (PDA) and other wireless and wireline digital information devices to quickly establish, or participate on, one or more personal private networks (PPN) over a local or wide geographical area.

With the aid of an PPN client server and a set of browser-based information management objects, the establishment, operation and dismantling of such a PPN configuration may be achieved by simply pointing-and-clicking, making it feasible for every computer or digital information device user to construct and operate his or her very own secure personal private network.

Accordingly, it is an objective of the present invention to provide every user of a computer or digital information device, whether it is connected to a wireline or wireless network, and whether the network is public or private, with the ability to be able to quickly and efficiently establish, operate and dismantle a highly secure personal private network (PPN).

Another objective of the present invention is to provide every user of a computer or digital information device the ability to create his or her PPN upon demand and allow the secure pipelines which form the PPN infrastructure to be directed to any specific recipient, point or party, or any multiple number of recipients, points and parties, as the PPN creator may desire, anywhere in the world.

Another objective of the present invention to provide a highly secure protection scheme for the transfer of communications and data over the PPN and to allow the sharing of sensitive, confidential and secret digital information through the communication features of the PPN.

Another objective of the present invention is to provide a security protection system which places minimal operational burdens upon the PPN creator and all of the participating members of the PPN.

Another objective of the present invention is to provide a PPN secure access key represented by a removable hardware-software media or device, such as a flash USB drive, a writable DVD, or CD or diskette, each which includes all of the programming code, data and logic required to allow any party who desires to use any computer or digital information device to create a PPN, or who desires to use any computer or digital information device to commence authorized participation on a PPN, and to gain such access and rights by simple inserting the removable storage device into a USB port, or the DVD or CD or diskette drive on the computer or digital information device, and initiating the PPN process.

And, another objective of the present invention is to provide full flexibility and mobility as to the physical locations and digital information devices which are utilized by the PPN creating source client and the one or more recipient clients of the PPN.

These and other objectives and advantages of the present invention will become clear to those skilled in the art in view of the description of the best presently known mode of carrying out the invention and the industrial applicability of the preferred embodiment as described herein and as illustrated in the several figures of the drawings.

To the accomplishment of the foregoing and related ends, the invention, then, comprises the features hereinafter fully described and particularly pointed out in the claims. The following description and the included drawings set forth in detail certain illustrative embodiments of the invention. These embodiments are indicative, however, of but a very few of the various ways in which the principles of the invention may be employed. Other objectives, advantages and novel features of the invention will become apparent from the following detailed description of the invention when considered in conjunction with the drawings and claims.

It is to be understood that both the foregoing general description and the following detailed description are exemplary and explanatory only and are not restrictive of the invention, as described. Further features and/or variations may be provided in addition to those set forth herein. For example, the present invention may be directed to various combinations and sub-combinations of the disclosed features and/or combinations and sub-combinations of several further features disclosed below in the detailed description.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1.—illustrates a diagram of the functional relationships of a PPN network in accordance with methods and systems consistent with the present invention. It shows the relationships of three required components: the Recipient Clients (RCs); the PPN Client Server (PPNCS); and the Source Clients (SC) and the optional component the Removable Storage Device (RSD);

FIG. 2.—illustrates a diagram of the functional relationships of a PPN network with the Internet and the Telephone Network in accordance with methods and systems consistent with the present invention;

FIG. 3.—illustrates a diagram of a sample architecture of a PPN network having features of the present invention which encompass both wireless and wireline communications in the implementation of the invention;

FIG. 4.—illustrates a diagram of a few sample applications of the PPN network in accordance with methods and systems consistent with the present invention;

FIG. 5.—illustrates a diagram of a few sample applications of the PPN network in accordance with methods and systems consistent with the present invention;

FIG. 6.—illustrates a diagram of a few sample applications of the PPN network in accordance with methods and systems consistent with the present invention;

FIG. 7.—illustrates an example of the sample steps associated with the establishment and maintenance of a PPN Directory by a source client;

FIG. 8.—illustrates an example of the sample steps associated with the establishment and operation of a PPN by a source client; and

FIG. 9.—illustrates an example of the sample steps associated with the establishment and maintenance of the PPN recipient client relationships.

### DETAILED DESCRIPTION OF THE PREFERRED EMBODIMENT OF THE INVENTION

Reference will now be made in detail to the construction and operation of an implementation of the present invention which is illustrated in the accompanying drawings. The present invention is not limited to this presented implementation but it may be realized by many other implementations.

The teachings of the present invention are applicable to many different types of computer networks and communication systems. As will be appreciated by those of ordinary skill in the art, while the following discussion sets forth various sample or even preferred implementations of the method and system of the present invention, these implementations are not intended to be restrictive of the provided claims, nor are they intended to imply that the claimed invention has limited applicability to one type of computer or communications network. In this regard, the teachings of the present invention are equally applicable for use in local area networks of all types, wide area networks, private networks, on-line subscription services, on-line database services, private networks, and public networks including the Internet and the World Wide Web and any other means of digital transfer of information. While the principles underlying the Internet and the World Wide Web are described in some detail herein below in connection with various aspects of the present invention, this discussion is provided for descriptive purposes only and is not intended to imply any limiting aspects to the broadly claimed methods and systems of the present invention.

Accordingly, as will be appreciated by those of ordinary skill in the art, as used herein, the term “client” refers to an individual who has authorized access to a digital information device, which maybe a client computer (or machine), in many functional and physical forms including but not limited to desk-tops, workstations, lap tops and PDAs, which are or can be attached to a network, or to a process, such as a Web browser, which runs on a client digital information device in order to facilitate network connectivity and communications. Thus, for example, a “digital information device” can store one or more “client processes.” The term “client” is also used in conjunction with the PPN server, “PPN client sever,” to represent the commonly used IT term of “client server.” The term “PPN secure access key,” also known as the removable storage device (RDS), refers to any hardware-software device which can digitally store and provide access to digital code, data and logic which as part of the present invention facilitates a party to become a participant of a PPN. Typically this would be represented with a flash USB drive but it could also be represented by a DVD, a CD, a computer diskette or some other form of portable and removable digital media device.

### Overview

The rapid increase in both the variety and popularity of wireless based communications and data transfer systems, including wireless accessible personal data assistants (PDA), wireless accessible lap-top and portable computers, wireless LANs and WANs for business and home use, and the current pursuit of many fixed based wireless applications, combined with the continued inadequacy of the wireless hardware and software industry to provide an effective security system for the transmission of data over a wireless network is one of the issues that has lead to the need for the subject invention.

Although many tools and products have been developed that address the security for wireless based transmissions the acceptance by consumers and the effectiveness of these solutions have been and remains inadequate.

In accordance with the aforementioned needs, the present invention is directed to a method and apparatus enabling both the specification and implementation of source client (SC) specified connection and delivery policies of a personal secure private computer network, defined as a personal private network (PPN). Specifically, in a computer network of heterogeneous nodes including receiving devices having potentially different capabilities, utilized by recipient clients (RCs), the present invention provides a method for a source client to specify the recipient client(s) to be authorized to participant in the PPN by enabling a source client to associate a secure pipeline for data delivery and reception of digital content to be communicated to and received from one or more receiving devices under the control of a specific recipient client. This secure pipeline providing a bi-directional secure data transmission media which as needed transcends all forms of digital transmission, including but not limited to wireline and wireless data transmission media.

In addition, methods are also provided for enabling a transmission—including the handling instructions, or policies—to be collected and unitized by a set of browser-based information management objects and an PPN client server, and other client servers and digital information devices, for processing by sending transmissions with the handling instructions, and delivering each component to the source client and each of the authorized recipient clients.

### DESCRIPTION OF OPERATIONS

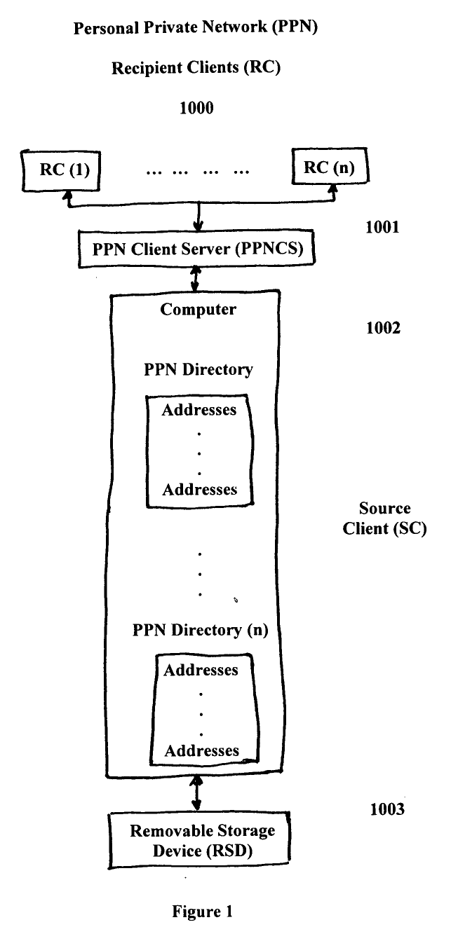

FIGS. 1 through 6 illustrate examples of operational architecture of a PPN network having features of the present invention. Shown in FIG. 1 is the SC's computer or digital device 1002 which includes one or more PPN Directories containing RC addresses. Also shown is the PPNCS 1001, and its position between the one or more Recipient Clients (RCs) 1000 and the SC's computer 1002. The “PPN secure access key” also known as the removable storage device (RDS) 1003 is also shown.

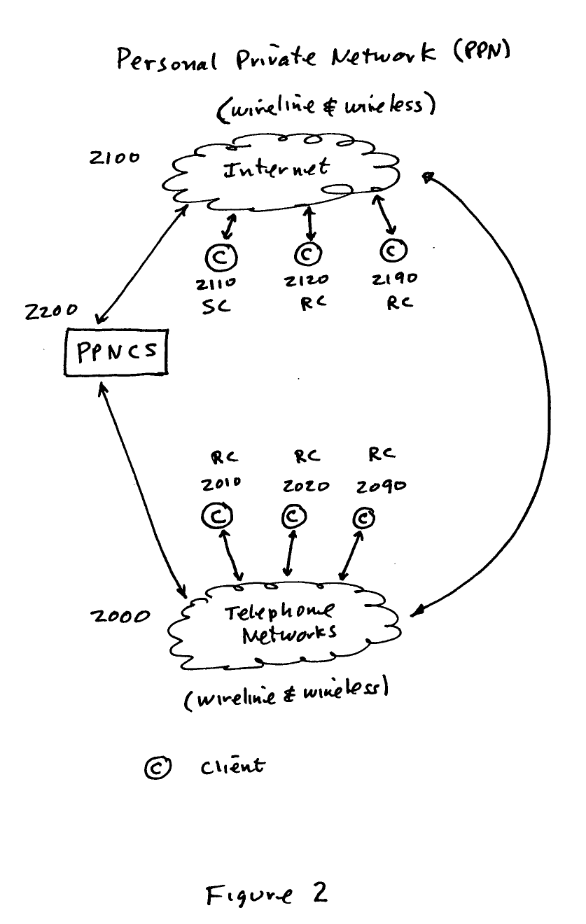

As shown, in FIG. 2, the PPN source client's (SC's) digital information device 2110, the one or more recipient clients (RC's) 2120 and 2190, and the PPN client server 2200 have communications connections to the Internet 2100. In addition, the one or more recipient client's (RC's) digital information device 2010, 2020 and 2090, and the PPN client server 2200 have communications connections to the Telephone network 2000. Furthermore, the Internet 2100 and the telephone network 2000 are directly connected.

Those with regular skill in the art will appreciate that the current invention may also be applicable to Intranets and other types of networks, in addition to the Internet 2100 and telephone networks 2000. They will also appreciate that any client (C) can be a source client (SC) and a plurality of clients can be recipient clients (RCs) where the number and specific identity of the recipient client is defined and authorized by the source client. They will also appreciate that any one of the (Cs) may use the PPN code and operation management controls resident in the connected computer or digital information device or may direct the connected computer or digital information device with a PPN secure access key (RSD).

A client (C) is a unique individual. Examples of a client's digital information device 2110, 2120, and 2190 include, but are not limited to, a PDA, a desk-top PC, a workstation, a laptop PC, a set-top box, etc. An example of the PPN client server 2200 includes a computer with ports or gateways that support connections with the Internet, Intranets, the Telephone network, and other networks that transfer digital information. Examples of the network 2100 include, but are not limited to, the Internet, the World Wide Web, an Intranet and local area networks (LANs), wide area networks (WANs). Examples of a Telephone network 2000 connected device 2010, 2020, and 2090 include, but are not limited to, a PDA, a desk-top PC, a lap-top PC, a wireless mobile or fixed station cell phone with processing and common browser capabilities, set-top box, etc.

In a preferred embodiment, a PPN is initiated by the source client 2110 to a PPN client server 2200. Those skilled in the art will appreciate that PPN initiations originating differently may be handled similarly. Other PPN initiation sources include, but are not limited to, anyone who is an individual with access to a digital information device with a connection to the Internet or a Telephone network.

A typical use and implementation for the present invention will now be considered with an illustrative example of an individual, shown in FIG. 2 as involving a businessman (source client) 2110 who has some confidential information which he desires to share and transfer to his attorney at the lawyer home office (recipient client) 2120 and the associate attorney (recipient client) 2020 located at an airport terminal, for the purpose of review and discussion.

The source client 2110 has a desk top PC operating as the digital information device which is on-line to the Internet via a cable modem. As the digital information device, the stationary recipient client 2120 has a workstation connected to the law office's local area network (LAN) that is connected to the Internet and the LAN includes a firewall. As the digital information device, the mobile recipient client 2020 has a lap-top computer connected via a wireless link to the telephone network.

Using the various functions provided by the present invention, some of which are discussed in the following paragraphs of this detailed description, the businessman 2110 (source client) using his PPN Directory, to which the subject recipient clients 2120 and 2020 having been previously entered, initiates a PPN secure pipeline to the lawyer's office 2120 and the traveling lawyer 2020 (recipient clients). The two recipients, 2120 and 2020, respond as present and prepare to participate in the discussion and review of the confidential information.

The two recipients proceed to open and consider the confidential data file which is the subject of this PPN activity, either by opening the confidential data file which is located on the hard drive of the source client 2110, or by securely transferring a copy of the confidential data file to their personal hard drive and thereafter opening the data file. Secure textual communications and comments are then provided to the reviewing committee participants via the PPN network. During this activity it is decided that the views and opinions of a patent lawyer 2190, at another law firm, are desired. The businessman 2110 using his PPN Directory, with the recipient client 2190 having been previously entered, initiates and authorizes the new participant 2190 (recipient client) to be joined into the PPN through the addition of another secure pipeline. The new recipient 2190 using his PPN secure access key responds as present and prepared to participant in the discussion and review of the confidential information.

All of the clients on the PPN are informed of the existence of the new PPN member 2190, the patent attorney, and all existing members on the PPN. The new participant obtains access to the source client's confidential data files and the group's textual communications and the review activities proceeds.

Soon thereafter the efforts of the patent attorney are completed and the source client deletes the patent attorney 2190 from the active PPN. The patent attorney thereupon removes his PPN secure access key from the computer. Upon completion of the review activities the source client 2110 dissolves the PPN.

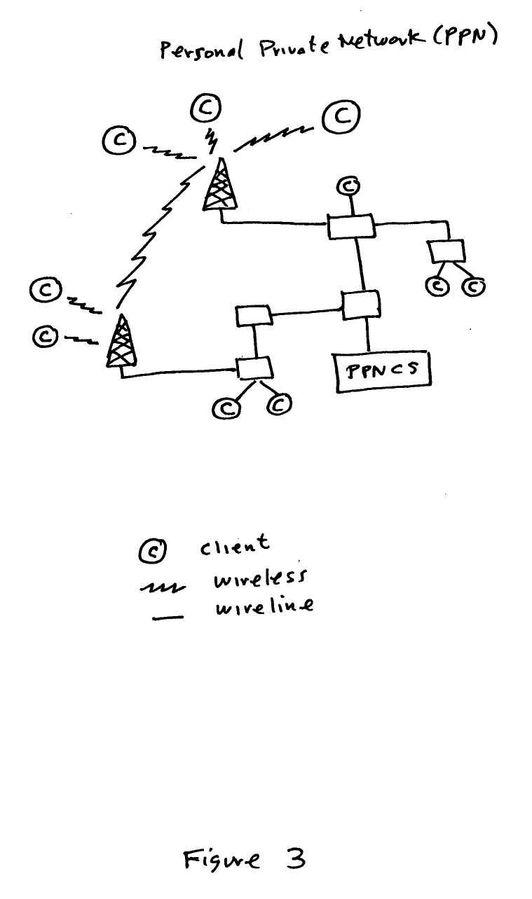

FIG. 3 expands upon the presentation of FIG. 2 by illustrating the architecture of a PPN network having features of the present invention which encompass both wireless and wireline communications in the implementation of the invention.

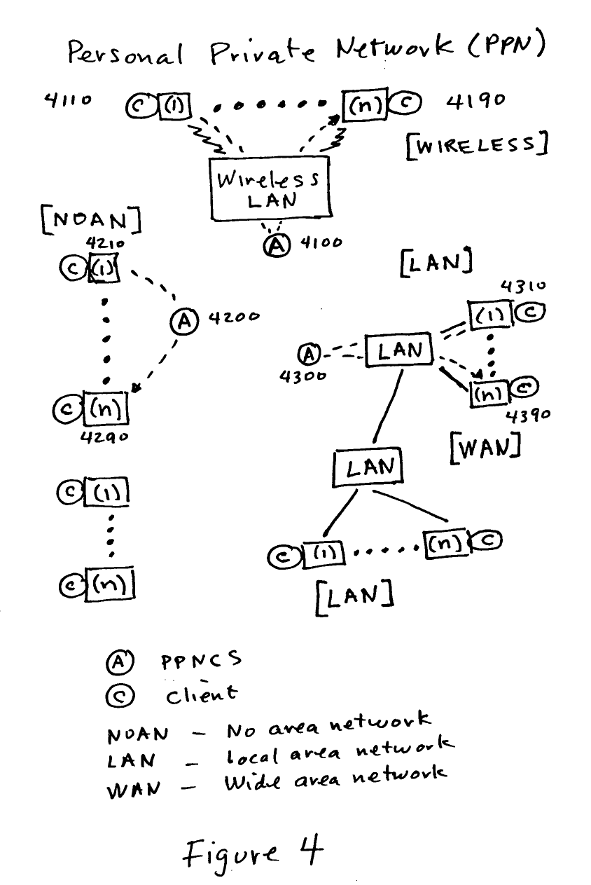

FIG. 4 expands upon the presentation of FIG. 2 by illustrating the architecture of a PPN network having features of the present invention which encompass both wireless and wireline communications in the implementation of the invention. Using an PPN client server 4100, a PPN operates from a wireless based LAN source client 4110 to a wireless recipient client 4190; via an PPN client server 4200, from a no-area network (NOAN), a source client 4210 operates with a NOAN recipient client 4290; via an PPN client server 4300, from a wireline based LAN a source client connects to a wireline recipient client 4390.

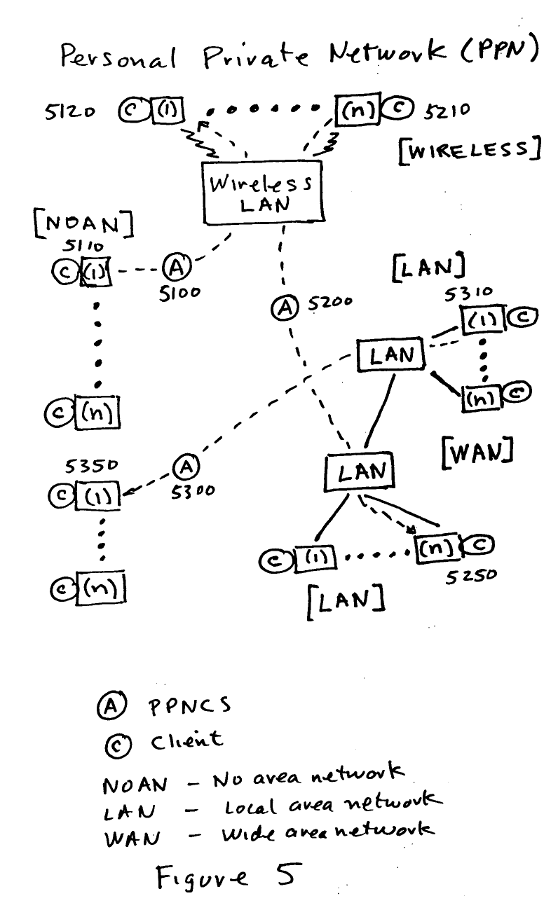

FIG. 5 expands upon the presentation of FIG. 2 by illustrating the architecture of a PPN network having features of the present invention which encompass both wireless and wireline communications in the implementation of the invention. Using an PPN client server 5100, a PPN operates from a NOAN based source client 5110 to a wireless recipient client 5120; via an PPN client server 5200, from a wireless LAN, a source client 5210 connects to a LAN recipient client 5250 operating within a WAN; via an PPN client server 5300, from a wireline based LAN, within a WAN, a source client connects to a NOAN recipient client 5350.

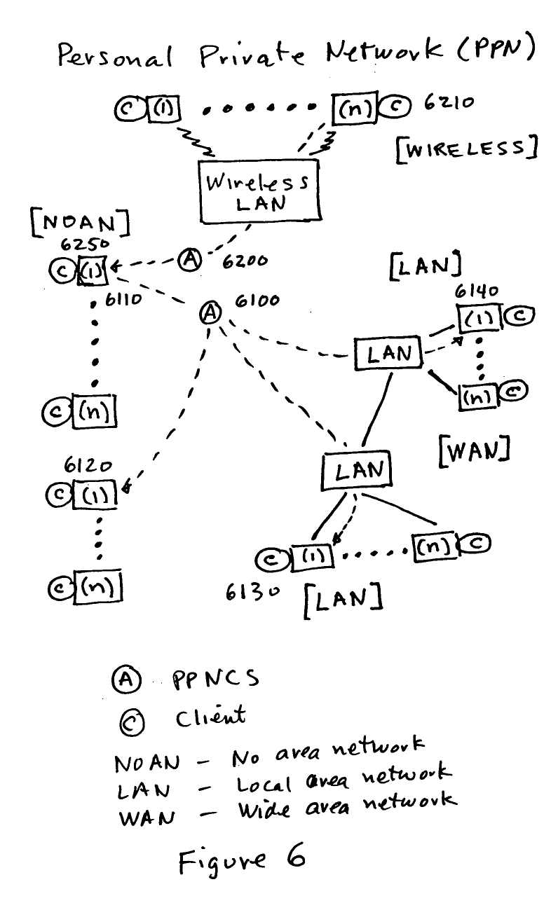

FIG. 6 expands upon the presentation of FIG. 2 by illustrating the architecture of a PPN network having features of the present invention which encompass both wireless and wireline communications in the implementation of the invention. Using an PPN client server 6100, a PPN can operate from a NOAN based source client 6110 to two wireline LAN recipient clients 6130 and 6140 operating within a WAN plus NOAN recipient client 6120.

This FIG. 6 also illustrates that a source client of a PPN can also simultaneously be a recipient client of another PPN, in this case the recipient client 6250 of the PPN established by the wireless source client 6210, and participating through the PPN client server 6200.

To provide for the ability to establish a PPN upon demand it is first necessary for the source client to create a PPN Directory. Within a PPN Directory is a listing the potential participants which the source client may need or desire to be included in a PPN which the source client establishes.

### Establishing a PPN Directory

Prior to the initiation of a PPN it is necessary for the contact address of each recipient client of any actual or planned PPN, which is to be established by the source client, to be listed in the source client's PPN Directory. This listing event is accomplished by each of the potential recipient clients registering with the PPN client server via a set of browser-based management objects. Upon completion of the registration event by the recipient client, the recipient client is available for participation on a PPN upon initiation of a PPN by the source client.

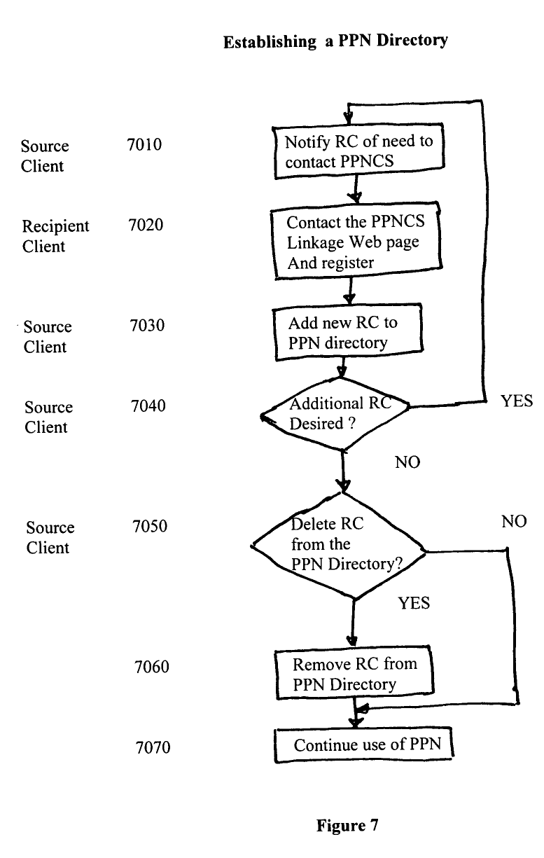

FIG. 7 illustrates an example of the steps associated with the establishment and maintenance of a PPN Directory by a source client. A PPN Directory is initialized by the notification 7010 of parties who either currently or in the future are intended or likely to be included in a PPN initiated by the source client. To be included or to update the current static and/or dynamic locations and address of an individual participant, the recipient client contacts the PPN client server web page and registers as a recipient client 7020. Such registration results in a set of browser-based management objects providing updated information to the PPN Directory 7030. If more participants are desired to be added to the PPN Directory this process is repeated 7040. If a current party in a PPN Directory needs to be deleted 7050 a set of browser-based management objects for the subject party is deleted 7060.

### Establishing an Operating PPN

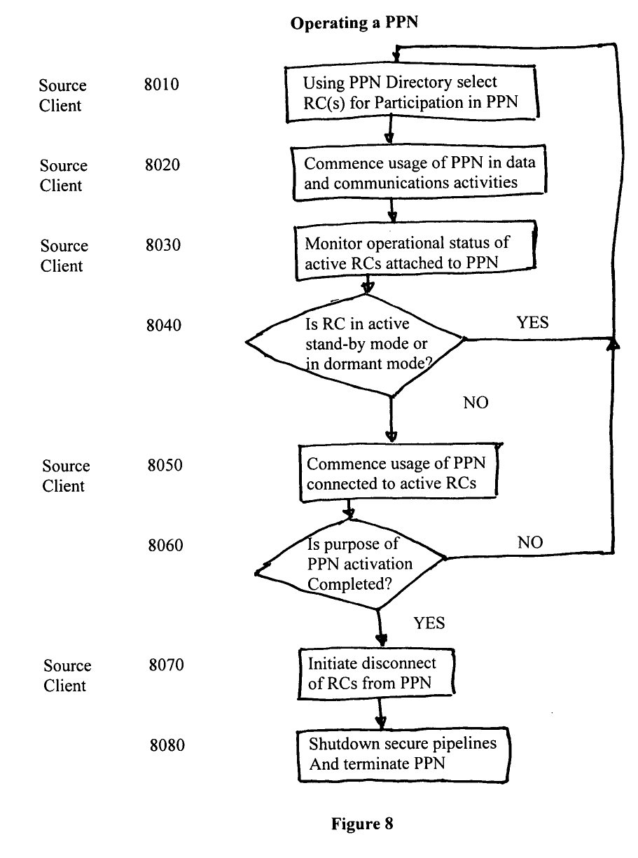

FIG. 8 illustrates an example of the steps associated with the establishment and operation of a PPN by a source client. A PPN is initialized by a source client by the selecting from the source client's PPN Directory the specific recipient clients that are to be included in this specific PPN 8010. Upon identification of the recipient participants a set of browser-based management objects, supported by the PPN client server, creates the required secure pipelines and the source client and the connected recipient clients can commence operational use of the PPN 8020. If one of more of the desired recipient clients do not respond to the initiation of the PPN, a set of browser-based management objects will monitor and report the active stand-by or the dormant status mode of the recipient clients 8030 and 8040. Typically, the term stand-by active means that the recipient client's digital information device is on-line and available for PPN activities, but that the individual recipient client is not actively participating in the PPN activities, i.e. he may be absent from his computer terminal. The term dormant status typically means that the recipient client's digital information device is not responding to the request to participant in the PPN, i.e. a dial-up device is not on-line or an on-line device is powered-off. If at any time the status of the monitored recipient client or the recipient client's digital information device changes, the source client is notified and if the status change allows the recipient client can commence participation in the PPN activities 8050. When the function or purpose for which the PPN was established is completed 8060 the recipient clients are removed from the PPN 7070 and the secure pipelines are removed and the PPN dissolved 8080.

### Managing PPN Recipient Client Relationships

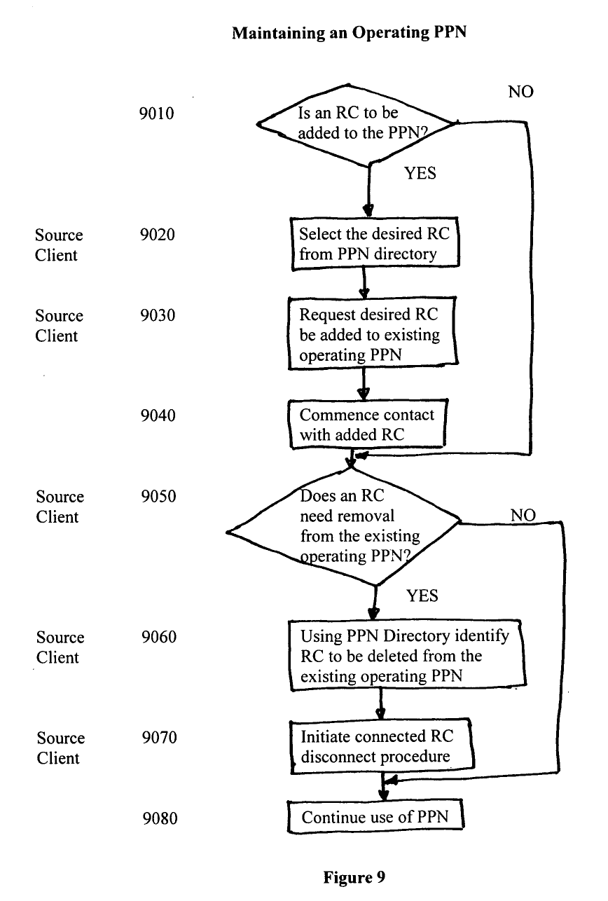

FIG. 9 illustrates an example of the steps associated with the establishment and maintenance of the PPN recipient client relationships. Following the initiation of a PPN, and prior to dismantlement, it may be desirable to add one or more recipient clients to the existing operational PPN 9010. If that is desired, the source client selects the desired new additional recipient client from his PPN Directory 9020. Upon indication from the source client a set of browser-based management objects, supported by the PPN client server, creates the required secure pipelines 9030 and the newly connected recipient clients can commence operational participation on the existing PPN 9040.

Similarly, following the initiation of a PPN, it may become desirable to remove one or more recipient clients from existing operational PPN 9050. If that is desired the source client selects the desired existing recipient client to be deleted from his PPN Directory 9060. Upon a deletion indication from the source client a set of browser-based management objects, supported by the PPN client server, delete the recipient client connection and delete the associated secure pipelines 9070 and the existing PPN continues to operate without the former deleted recipient client 9080.

Those skilled in the art will appreciate that the secure pipeline information transfer method of the present invention is not limited to an PPN client server. The present invention also applies to other type of servers, such as an e-commerce or financial transaction server which provides a transformation and translation of commerce transactions.

Now that a preferred embodiment of the present invention has been described, with alternatives, various modifications and improvements will occur to those of skill in the art without departing from the spirit and scope of the invention. For instance, an PPN client server and a digital information device need not be embodied in separate devices, i.e: the functionality of the PPN client server may be included within and performed by a detail information device. Thus, the detailed description should be understood as an example and not as a limitation. The proper scope of the invention is properly defined by the included claims.

1. A personalized private network (PPN), comprising:
two or more participating parties (clients) with digital information devices each with an Internet or network oriented enabled set of objects that links the client to a computer network infrastructure to establish and maintain a secure connection between the client and the PPN client server of a PPN;
a PPN client server (PCS) that receives and responds to the requests or communications received from any actual or potential PPN client having, through a set of enabled objects, access to the computer network infrastructure;
a set of browser-based management objects (BBMO) that allow any actual or potential source participant (source client (SC)) that is capable of accessing a computer network infrastructure through a set of enabled objects to setup and maintain a PPN;
a set of browser-based management objects that allows any actual or potential recipient participant (recipient client (RC)) that is capable of accessing the computer network infrastructure through a set of enabled objects to establish and maintain a communication relationship with a source client and potentially a plurality of recipient clients of a PPN;
a set of browser-based information management objects that allows a plurality of recipient clients, that have been authorized by a source client, to access and participate in the transfer of communication and data though a PPN;
a customized infrastructure of PPN secure pipelines created by the PPN client server at the direction of the source client specifically to fulfill the point to point communications requirements defined by the source client;
an encryption process which utilizes the U.S. Government approved Advanced Encryption System (AES), or other encryption scheme, as the encrypted format, between the plurality of recipient clients and the source client on the established PPN;
where the keys to the encrypted format of the data transferred over all of the secure pipelines is keyed with a set of manually established key inputs and a set of automated key inputs that are combined according to a PPN based cryptographic algorithms to create a secure key access code;
a set of browser-based information management objects that allows the source client at his discretion to disconnect and terminate from access and participation on the PPN, any one or all of the plurality of, recipient clients on the established PPN;
a set of browser-based information management objects that allows the source client and the recipient participants to monitor the real-time communications access status and access rights to each RC and SC on an established PPN;
a set of browser-based information management objects that allows any authorized RC on a PPN to withdraw from an active connection, and also return to an active connection status on an established PPN;
a set of browser-based information management objects that operates an RC authentication system located at least partially within the secure PPN network, the secure PPN being configured to allow direct access to the PPN client server by an RC only after the RC is authenticated by the client authentication system;
a set of browser-based information management objects that operates a resource locator transformer which modifies non-secure resource locators in data being sent from the PPN client server to the RCs and SC by replacing them with corresponding secure resource locators; and
the physical components of a least one or more Recipient Clients (RCs); one or more the PPN Client Server (PPNCS); and one or more Source Clients (SCs) and the optional component, one or more Removable Storage Devices (RSDs).

2. Wherein the PPN defined in claim 1, including the browser-based information management objects, enables many different kinds of computers and digital information devices, such as, but not limited to, desk-top and lap-top personal computers (PCs); workstations, personal digital assistants (PDAs); and other wireline and wireless digital information devices, to connect and maintain access to a PPN; and thereby allowing the PPN to operate from and across many types of communication media and digital information devices; and, in effect, making the PPN a computer and network platform-independent operation.

3. Wherein the PPN defined in claim 1, including the browser-based information management objects, enables many different kinds of computers and digital information devices, such as, but not limited to, desk-top and lap-top personal computers (PCs); workstations, personal digital assistants (PDAs); and other wireline and wireless digital information devices to simultaneously access the PPN; and to utilize the existing network resources such as, but not limited to, network printers, servers and disk storage.

4. Wherein the PPN defined in claim 1, including the browser-based information management objects, enables many different kinds of computers and digital information devices, such as, but not limited to, desk-top and lap-top personal computers (PCs); workstations; personal digital assistants (PDAs); and other wireline and wireless digital information devices; to perform remote access from remote sites through standard Internet browsers.

5. Wherein the PPN defined in claim 1, enables many PPN clients (both RCs and SC) utilizing many different kinds of computers and digital information devices to simultaneously setup and maintain a uniquely identifiable and separately operated PPN, where the source client can originate, maintain and operate a PPN from an desk top PC; a workstation; a laptop; a personal digital assistant (PDA); or any other digital information device which can gain access to the Internet, an Intranet, or some other media which allows the browser-based information management objects to transfer digital information between two or more clients.

6. Wherein the PPN defined in claim 1, enables browser-based information objects to perform queries, to transfer of digital information, and to retrieve information by and between PPN clients in a secure environment.

7. Wherein the PPN defined in claim 1, enables operation in a digitally secure environment between the PPN clients by creating one or more secure digital pipelines, providing secure communications, irrespective of the medium of digital communications, including, but not limited to, such media as wireline and wireless systems and networks.

8. Wherein the PPN defined in claim 1, enables operations in a digitally secure environment between the PPN clients by creating one of more secure digital pipelines, providing secure communications, irrespective of the operating environment from which the participating PPN client resides, or through which the secure pipeline must pass, including, but not limited to, such operating environments as wide area networks (WANs), local area networks (LANs) and open access, or no-area-networks (NOANs).

9. Wherein the PPN defined in claim 1, enables every PPN client utilizing many different kinds of computers and digital information devices to simultaneously query, access, transfer and retrieve information between PPN clients who are attached to a specific PPN.

10. Wherein the PPN defined in claim 1, enables a PPN client to actively and simultaneously participate as a client on one or more PPNs.

11. Wherein the PPN defined in claim 1, enables the PPN client server using an Internet or network oriented enabled set of objects and secure pipeline software to create a secure tunnel between the PPN client and the PPN client server through any and all firewalls, border or network servers and other digital devices.

12. Wherein the PPN defined in claim 1, is configured to allow direct access to the authorized PPN clients using network addresses within the secure PPN while denying direct access from unauthorized network addresses outside of the PPN.

13. Wherein the PPN defined in claim 1, is configured to allow direct access to the authorized PPN clients by transmitting communications and data to the PPN clients over secure pipeline tunnels through any and all firewalls and network servers and establishes a secure digital data pipeline for continued use by the PPN clients during the useful operational life of the PPN.

14. Wherein the PPN defined in claim 1, is configured as a personal, source client (SC) defined, private, secured intranet to which the source client may add and delete recipient clients and through which all participating clients may query, receive, transfer and distribute data and information.

15. Wherein the PPN defined in claim 1, enables the SC and the recipient client (RC) to collect, store and upon demand utilize the code, data and logic needed to create a PPN and to participate in a PPN and that such embodiment may reside in any digital median including a computer hard drive or a PPN secure access device, such as a flash USB drive, a DVD, a CD, a diskette or other form of removable media device. Additionally, all of the PPN secure pipeline creation and infrastructure mapping for the enablement of the PPN, plus access controls and codes for authorizing participation and initiating participation and disconnection can be encased in a PPN secure access key.

16. Wherein the PPN defined in claim 1, the using steps include, but are not limited to, each PPN client providing to the PPN client server:
a client user name and a user password;
a request for access to the PPN client server;
a request for the creation of a secure connection between the PPN client server and the PPN client by and through any and all firewalls, border or network servers and other digital devices;
the identification of the specific PPN to which the secure connection is to be attached;
a PPN client authentication system to authenticate the right of the client to access the specified PPN;
an indication that the PPN client is operating in a stand-by state; a live state; a dormant state or such other states of communication participation; and
a request for termination of participation in the PPN.

17. A method of providing secure pipeline connections between a source client's digital information device and one or more recipient client's digital information device, comprising:
through the use of a set of browser-based management objects, receiving, at the PPN client server, information regarding the source client digital device and the one or more recipient client's digital devices sufficient to facilitate establishment of a secure pipeline connection between a source client's digital information device and one or more recipient clients' digital information devices;
by first creating an end-to-end secure private digital data link between a source client's digital information device and the PPN client server; and
second by creating a second end-to-end secure private digital data link between the one or more recipient clients' digital information devices and the PPN client server; and
thereby establishing a secure, private pipeline connections between the parties that is functionally administered as to the establishment, the addition and the deletion of clients and maintenance of the security by an PPN client server, who's actions are directed by the creating client the source client.

18. A data processing system which utilizes mini-web browsers operating on the digital information device of a participating individual's digital network access device for providing a connection between an initiating computer or digital network access device and one or more recipient computers or digital network access devices, comprising:
a PPN client server that receives information regarding the requests of these accessing devices, thought the use of a set of browser-based management objects, to facilitate the establishment and on-going operations of a secure connections between these multiple computers and digital network access devices;
one initiating computer or digital network access devices;
one or more recipient computers or digital network access devices; and
an end-to-end secure digital data transfer link between the initiating computer or digital network access device and one or more recipient computers or digital network access devices.

19. A computer-readable medium containing instructions for controlling a computer network to perform a method for providing a connection and a secure pipeline between a source computer and a response computer, or a plurality of response computers, where the term computer means any device which will function to provide access to a network infrastructure and will support the operation of a mini-web browser and the use of a set of browser-based management objects, the method comprising:
receiving, at a third computer, also known as an PPN client server, a set of browser based management objects information provided by the source and the response computer's mini-browsers, browser-based management objects and additional information received by the web browser operated by the PPN client server regarding the source and the response computers such as to facilitate the establishment of a secure connection between the source computer and the one or more response computers;
using such information and specific browser-based management object's information to create, first an end-to-end secure link between the source computer and PPN client server;
next, to create a second end-to-end secure links between the one or more response computers and the PPN client server;
thereafter, to merge these multiple end-to-end secure links into a network of secure pipelines and create a personal private network (PPN) which is serviced by the PPN client server, a set of browser-based management objects and directed by the source computer; and
to maintain and operate the PPN until directed by the source computer or other events to dismantle the network.

20. A system for enabling an individual user to establish and control the member participants of a network between a first processor (the digital information device within the control of the PPN network creating user) and a second processor (the digital information device within the control of the PPN network recipient user), wherein the first and second processors are separate from said system and are each identifiable by a name, said system comprising:
a tunneling interface that provides for one or more processors separate from the system a set of names that includes the name of the first processor, receives information indicating on behalf of the first processor a selection of one or more of the names in the set of names, receives information indicating a consent on behalf of the first processor for enabling a tunnel extending from the first processor to the second processor, and receives information indicating a consent on behalf of the second processor for enabling a tunnel extending from the second processor to the first processor, wherein the indication of consent on behalf of the second processor includes selecting the name of the first processor; and
a controller that determines a first virtual address for the first processor and a second virtual address for the second processor such that the first and second virtual addresses uniquely identify the first and second processors, respectively, and are routable through the network, and that provides to each of the first and second processors the first and second virtual addresses to enable one or more tunnels between the first and the second processors.

21. The system of claim 20, including the ability for supporting a single first processor and a plurality of second processors within a personal private network (PPN).

22. The system of claim 20, including the ability for full and complete encryption security of all data transferred through the tunnels.

23. The system of claim 20, including the ability for full and complete independent operations and support of a plurality of simultaneously operating and functioning, and totally independent PPNs
